(19) United States
(12) Patent Application Publication
(10) Pub. No.: US 2016/0043888 A1
(43) Pub. Date: Feb. 11, 2016

(54) Low complexity PAPR suppression method in FRFT-OFDM system

(71) Applicants: Ran Tao, Beijing (CN); Hao Huan, Beijing (CN); Yue Zhao, Beijing (CN); Teng Wang, Beijing (CN)

(72) Inventors: Ran Tao, Beijing (CN); Hao Huan, Beijing (CN); Yue Zhao, Beijing (CN); Teng Wang, Beijing (CN)

(73) Assignee: Beijing Institute of Technology, Beijing (CN)

(21) Appl. No.: 14/886,056

(22) Filed: Oct. 18, 2015

Related U.S. Application Data
(63) Continuation of application No. PCT/CN2013/082060, filed on Aug. 22, 2013.

(30) Foreign Application Priority Data
Apr. 22, 2013 (CN) 201310142185.5

(51) Int. Cl. H04L 27/26

(52) U.S. Cl. CPC H04L 27/2614; H04L 27/263

(57) ABSTRACT

The invention relates to a method that low complexity suppression of PAPR in FRFT-OFDM system, which belongs to the field of broadband wireless digital communications technology and can be used to reduce the PAPR in FRFT-OFDM system. The method is based on fractional random phase sequence and fractional circular convolution theorem, which can effectively reduce the PAPR of system. The method of the invention has the advantages of simple system implementation and low computational complexity. In this method, the PAPR of the system can be effectively reduced while keeping the system reliability. When the number of candidate signals is the same, the PAPR performance of the proposed method was found to be almost the same as that of SLM and better than that of PTS. More importantly, the proposed method has lower computational complexity than that of SLM and PTS.

### CROSS-REFERENCES AND RELATED APPLICATIONS

This application claims priority of the international application PCT/CN2013/082060, filed Aug. 22, 2013, which claims priority of Chinese Application No. 201310142185.5, entitled “A low complexity PAPR suppression method in FRFT-OFDM system”, filed Apr. 22, 2013, which are herein incorporated by reference in their entirety.

### BACKGROUND OF THE INVENTION

1. Field of the Invention

The invention relates to a low complexity suppression of PAPR in FRFT-OFDM system, and belongs to the field of broadband wireless digital communications technology. This method can be used to reduce the PAPR in FRFT-OFDM Systems.

2. Description of the Related Art

Cadmium is a Traditional orthogonal frequency division multiplexing (OFDM) systems typically transform from time domain to frequency domain by a discrete Fourier transform (DFT). Shift frequency selective channel into multiple flat sub channels, and then the serial high-speed data stream is converted into a multi parallel low-speed data stream, which makes the OFDM system has good anti multipath fading performance. However, in the double frequency dispersion channel, the orthogonality between subcarriers is susceptible to damage in OFDM system, thereby forming a serious inter-carrier interference. To overcome this issue, Martone Massimiliano proposed OFDM system which is based on fractional Fourier transform that acronym FRFT-OFDM system. And results that FRFT-OFDM systems has better transmission performance than traditional OFDM system in the fast varying channel. Meanwhile, FRFT (Fractional Fourier Transform) has complex calculations which is similar to FFT (Fourier transform) and easy to implement. Therefore, FRFT-OFDM system has great value.

However, the issue of high PAPR existed in the FRFT-OFDM system (a multi-carrier transmission system) cannot be ignored resulted from the influence on the operating cost and efficiency of the system. At present, the PAPR suppression of FRFT-OFDM system is that only directly applied the traditional OFDM system to it. PAPR suppression of traditional OFDM system include: limiting, selective mapping (SLM), part of the transmission sequence (PTS), effective Constellation Extension Act (ACE) and so on. Although some scholars have applied the traditional SLM and PTS to the FRFT-OFDM system and the peak of the system has been improved significantly, but the two methods have the problem of large computational complexity. At the same time, some scholars have proposed the OCSPS and CSPS for the problem of large computation in PTS in the traditional OFDM system. However, due to the existence of periodic of chirp in the fractional Fourier transform, the method can't be directly applied to the FRFT-OFDM system.

In the following, we introduce the fractional Fourier transform, its discrete algorithm and fractional convolution theorem.

Fractional Fourier transform is a generalized form of Fourier transform. As a new tool of time-frequency analysis, FRFT can be interpreted as a signal in the time-frequency plane of the axis of rotation around the origin. FRFT of signal x (T) is defined as:

Xₚ(u)={Fₚ[x(t)]}(u)=∫_{-∞}^{+∞}x(t)·Kₚ(t,u)dt (1)

Which: p=2·α/π is the order of the FRFT; α is the rotation angle; Fₚ[•] is the operator notation of FRFT; Kₚ(t,u) is the transform kernel of FRFT:

$${K}_{p} ( t , u ) = \{ \begin{matrix}\sqrt{\frac{1 - j \cdot cot α}{2 π}} \cdot exp ( j \cdot \frac{{t}^{2} + {μ}^{2}}{2} \cdot cot α - j \cdot u \cdot t \cdot c sc α ) & α \neq n π \\ δ ( t - u ) & α = 2 n π \\ δ ( t + u ) & α = ( 2 n \pm ) π\end{matrix} \qquad ( 2 )$$

Inverse transform of FRFT is:

x(t)=∫_{-∞}^{+∞}Xₚ(u)·K₋ₚ(t,u)du (3)

Discrete fractional Fourier transform (DFRFT) is required in practical application. At present, there are several different types of DFRFT, which have different accuracy and computational complexity. The difference between the invention and the commonly used fast decomposition algorithms that Soo-Chang Pei proposed that direct input and output sampling DFRFT fast algorithm in 2000 is selected in this invention. The algorithm can maintain accuracy and complexity of fast decomposition algorithms are equal (The computational complexity is O(N log₂ N), and N is the of points sample), while keeping orthogonality of DFRFT conversion nuclear by defining the input and output sampling interval. It can recover the original sequence at the output end by inverse discrete transformation.

The input and output of FRFT are sampled by Δt and Δu, when M≧N, and the sampling interval is satisfied:

Δu·Δt=|S|·2π·sin α/M (4)

Which: M is the output sampling points of fractional Fourier domain; N is input sampling points in time domain; |S| is positive integers which is mutually prime numbers of M (usually taken as 1); DFRFT can be expressed as:

$$\{ \begin{matrix}\begin{matrix}{X}_{α} ( m ) = {A}_{α} \cdot {e}^{\frac{j}{2} \cdot co t α \cdot {m}^{2} \cdot Δ {u}^{2}} {\sum }_{n = 0}^{N - 1} {e}^{\frac{j}{2} \cdot co t α \cdot {n}^{2} \cdot Δ {t}^{2}} \cdot \\ {e}^{- \frac{j 2 π \cdot n \cdot m}{M }} \cdot x ( n ) ,\end{matrix} & α \neq D \cdot π \\ {X}_{α} ( m ) = x ( m ) , & α = 2 D π , \\ {X}_{α} ( m ) = x ( - m ) , & α = ( 2 D + 1 ) π\end{matrix} \qquad ( 5 )$$

Which:

$${A}_{α} = \sqrt{\frac{sin α - j \cdot cos α}{N} } ,$$

D is integer.

Convolution theorem plays an important role in the signal processing theory which is based on the traditional Fourier transform. The fractional convolution theorem is proposed in 1998 by Zayed. According to the definition, the p-order fractional convolution of the signal x(t) and g(t) is defined as:

$$\begin{matrix}y ( t ) = x ( t ) {⊗}^{p} g ( t ) \\ = \sqrt{\frac{1 - j \cdot cot α}{2 π}} \cdot {e}^{- j \cdot \frac{1}{2} \cdot co t α \cdot {t}^{2 }} \cdot {\int }_{- ∞}^{∞} x ( τ ) \cdot {e}^{j \cdot \frac{1}{2} \cdot co t α \cdot {t}^{2}} \cdot \\ g ( t - τ ) \cdot {e}^{j \cdot \frac{1}{2} \cdot co t α \cdot {( t - τ )}^{2}} d τ\end{matrix} \qquad ( 6 )$$

Which: α=p·π/2. In the domain of p-order fractional Fourier, the relationship between fractional Fourier transform of continuous signals x(t), g(t) and fractional Fourier transform of continuous signals y(t) which is obtained by fractional convolution of continuous signals x(t), g(t) is:

$${Y}_{p} ( u ) = {X}_{p} ( u ) \cdot {G}_{p} ( u ) \cdot {e}^{- j \cdot \frac{1}{2} \cdot co t α \cdot {u}^{2}} \qquad ( 7 )$$

Which: Xₚ(u), Gₚ(u) is p-order FRFT of x(t), g(t); Yₚ(u) is p-order FRFT of y(t). That is to say, fractional convolution of two time-domain signal is multiplied by their FRFT of which the product is multiplied by a chirp signal. In the same way, the fractional convolution formula can be obtained in time domain.

The fractional convolution theorem is aimed at the fractional convolution of two continuous signals in time domain. However, in engineering, processed signal is the discrete time-domain signal generally. Fractional circular convolution theorem of discrete signals is defined as follows:

$$\begin{matrix}{Y}_{p} ( m ) = {X}_{p} ( m ) {G}_{P} ( m ) {e}^{j - \frac{1}{2} co t α {m}^{2} Δ {u}^{2}} & ( 8 a ) \\ y ( n ) = x ( n ) {{⊗}_{p}}^{N} g ( n ) & ( 8 b )\end{matrix}$$

Which: y(n)=IDFRFT(Yₚ(m)), x(n)=IDFRFT(Xₚ(m)), g(n)=IDFRFT(Gₚ(m)),

$${{⊗}_{p}}^{N}$$

n-point circular convolution Fractional which order is p.

### SUMMARY OF THE INVENTION

It is an aim of present invention that solve above-mentioned problem of high PAPR. The present invention proposes a low complexity suppression of PAPR in FRFT-OFDM system. The method is based on fractional random phase sequence and fractional circular convolution theorem, which can effectively reduce the PAPR of system.

The technical scheme of the invention is: the invention relates to a low complexity suppression of PAPR in FRFT-OFDM system. In this method, the random phase sequence is extended to the same length as the FRFT-OFDM symbol by the way of periodic continuation. To effectively suppress the PAPR by the way that the data after phase factor weighting is multiplied by the data before subcarrier modulation. In this method, the PAPR of the system can be effectively reduced while keeping the system reliability. When the number of candidate signals is the same, the PAPR performance of the proposed method was found to be almost the same as that of SLM and better than that of PTS. More importantly, the proposed method has lower computational complexity.

The basic principle of this method is to obtain the FRFT-OFDM symbol x(n) in time domain after subcarrier modulation by a N-point IDFRFT. All the candidate signals are obtained by the method that making the x (n) periodic continuation and the circular shift based on chirp, and then the results are weighted. This method avoids the parallel computation of multiple N points of IDFRFT like SLM and PTS.

The steps of the method are:

(1) Carry out N-point IDFRFT of the complex data X after digital modulation which length is N at sending end of communication system. After the process of subcarrier modulation, FRFT-OFDM symbols x(n) in time domain can be obtained; N is number of subcarriers; IDFRFT is inverse discrete fractional Fourier transform; x(n) is symbol of time-domain FRFT-OFDM symbol.

(2) According to periodic of chirp, making out p-order periodic extension of the x(n) in time domain of chirp and obtaining extended sequence which is represented as x((n))_{P,N}. p-order discrete fractional Fourier converted into the formula of periodic extension in time domain of chirp is:

$$x ( n - N ) {e}^{j \frac{1}{2} co t {α ( n - N )}^{2} Δ {t}^{2}} = x ( n ) {e}^{- j \frac{1}{2} co t α {n}^{2} Δ {t}^{2}} \qquad ( 9 )$$

chirp is a linear FM; p is the order of Fractional Fourier Transform; x((n))_{P,N} is the extended sequence which is obtained by p-order periodic extension of chirp in time domain; N is the cycle length of chirp (in the present invention, the cycle length of chirp is equal to the number of sub carriers); α=pπ/2, dt is the sampling interval of continuous signals.

(3) Move x((n))_{P,N} to the right with the iM (i=1, 2, . . . L) point, take the main value range of x((n))_{P,N} and obtain chirp circumferential displacement of FRFT-OFDM time domain signal—x((n−iM))_{P,N}R_{N}(n); L is the length of the random phase sequence.

(4) Multiply x((n−iM))_{P,N}R_{N}(n) and

$$η ( n , i ) = {e}^{j \frac{1}{2} co t α [ - 2 i M n + {( iM )}^{2} ] Δ {t}^{2 }}$$

by point, get φ(n,i) is:

φ(n,i)=x((n−iM))_{P,N}R_{N}(n)η(n,i),i=0,1 . . . L−1,n=0,1, . . . ,N−1 (10)

(5) Weighted stacking of by φ(n,i) by r^{(l)}(i), get candidate signals \tilde{x}^{(l)}(n) of FRFT-OFDM in time domain is:

$${\tilde{x}}^{( l )} ( n ) = {\sum }_{i = 0}^{L - 1} {r}^{( l )} ( i ) ϕ ( n , i ) , n = 0 , 1 … N - 1 , , l = 1 , 2 , … S \qquad ( 11 )$$

S is the number of alternative Fractional random phase sequence.

(6) Select the minimum candidate signals \tilde{x}^{(l)}(n) of PAPR in time domain as transmission signals. The weighting factor r(i)ₒₚₜ which can make PAPR of candidate signals minimum in time domain is used as sideband information, and send it to receiving end. According to sideband information r(i)ₒₚₜ, the receiving end recovers sending-information.

$${r ( i )}_{opt} = {arg min PARP \{ {\tilde{x}}^{( l )} ( n ) \}}_{\{ {r}^{( 1 )} ( i ) , … , {r}^{( S )} \}} \qquad ( 12 )$$

The present invention has the following advantages: This method can effectively reduce the PAPR of the system while keeping the system reliability. When the number of candidate signals is consistent, the PAPR performance of the proposed method was found to be almost the same as that of SLM and better than that of PTS. The method of the invention has the advantages of simple system implementation and low computational complexity. Because the discrete fractional Fourier transform has a fast method, the computational complexity is equivalent to FFT, so the method is easy to be implemented.

### DETAILED DESCRIPTION

The derivation process of a low complexity suppression of PAPR in FRFT-OFDM system is briefly described below:

A. Design Fractional Order Random Phase Sequence

R is a random phase sequence with L-length, R=[R(0), R(1), . . . , R(L−1)] (which R(i)=e^{jθ}^{ₖ}, i=0, 1, . . . L−1, θₖ evenly distributed in the [0,2π]); N is an integer multiple of L, that is N/L=M. The sequence R is periodicity extended into the random phase sequence with N-length Q (Q=[Q(0), Q(1), . . . , Q(N−1)]), that is:

Q(m)=R((m))_{L},m=0,1 . . . N−1 (13)

Make phase factor

$${e}^{j \frac{1}{2} cot α {m}^{2} {Δμ}^{2}}$$

weighting each element in a Q sequence, and then B=[B(0), B(1), . . . , B(N−1)] is obtained. Which: B is fractional random phase sequence that will be designed.

$$B ( m ) = Q ( m ) {e}^{j \frac{1}{2} cot α {m}^{2} {Δμ}^{2}} , \\ m = 0 , 1 , … , N - 1 \qquad ( 14 )$$

Which: α=pπ/2,

$$Δμ = \frac{2 π \vert sin α \vert}{N Δ t}$$

is sampling interval of p-Order fractional Fourier domain sampling interval; dt is sampling interval of continuous signal; it can be seen from formula (11) and formula (12):

The fractional order random phase sequence is obtained by FRFT signal weighting each element in a short random phase sequence which is periodic extended to the same length as symbol of FRFT-OFDM.

By the following formula, inverse discrete fractional Fourier b=[b(0), b(1), . . . b(N−1)] of B can be obtained:

$$\begin{matrix}\begin{matrix}b ( n ) = IDFrFT \{ B ( m ) \} \\ = \sqrt{\frac{sin α + jcosα}{N}} {e}^{j \frac{1}{2} cot α {m}^{2} Δ {t}^{2}} {\sum }_{m = 0}^{N - 1} B ( m ) {e}^{j \frac{2 π}{N} nm} {e}^{- j \frac{1}{2} cot α {m}^{2} Δ {u}^{2}}\end{matrix} & ( 15 ) \\ n = 0 , 1 … , N - 1 & \end{matrix}$$

The formula (11) and the formula (12) are brought into the formula (13):

$$b ( n ) = N \sqrt{\frac{sin α + jcosα}{N}} {e}^{j - \frac{1}{2} cot {α ( i M )}^{2} Δ {t}^{2}} {\sum }_{i = 0}^{L - 1} r ( i ) δ ( n - i M ) \\ n = 0 , 1 … N - 1 \qquad ( 16 )$$

Which: r(i)=IDFT{R(m)}. From the formula (14) can be seen that sequence B with N-length. After inverse discrete fractional Fourier transform of B, the time domain b^{(l)} sequence is obtained which is only related to r^{(l)}(i), and the number of non-zero is only L.

B. The method of Low Complexity PAPR Suppression

As the basic principles of SLM method, multiply alternative random phase sequence B whose number is S is multiplied by the data before subcarrier modulation, and then alternative signals X̅^{(l)} whose number is S can be obtained:

X̅^{(l)}=XB^{(l)}=[X(0)B^{(l)}(0),X(1)B^{(l)}(1), . . . ,X(N−1)B^{(l)}(N−1)],l=1,2, . . . S (17)

Then, make these alternatives IDFRFT, and obtain alternative symbol x̅^{(l)} whose the number is S of time-domain FRFT-OFDM.

x̅^{(l)}=IDFrFT{ X̅^{(l)}} (18)

Fractional circular convolution theorem:

If

$${X}^{( l )} = X {B}^{( l )} {e}^{- j \frac{1}{2} cot α {m}^{2} Δ {u}^{2}} \qquad ( 19 a )$$

Then

$${x}^{( l )} = x {⊗}_{P}^{N} {b}^{( l )} \qquad ( 19 b )$$

Which:

$${⊗}_{P}^{N}$$

is n-point circular convolution Fractional with p-order. x is N-point inverse discrete fractional Fourier transform of X; b^{(l)} is N-point inverse discrete fractional Fourier transform of B^{(l)}. Contrast formula (15) and formula (17.a), X̅^{(l)} need to be amended.

Make

$${X}^{( l )} ( m ) = {\overline{X}}^{( l )} ( m ) {e}^{j - \frac{1}{2} cot α {m}^{2} Δ {u}^{2}}$$

(after receiving end making DFRFT, X̅^{(l)} can be obtained easily by multiplied a phase factor

$${e}^{j \frac{1}{2} cot {α ( m )}^{2} Δ {u}^{2}} )$$

as the candidate signals of this method. And then N-point IDFRFT of X^{(l)} is:

$${\overline{X}}^{( l )} {x}^{( l )} = IDFrFT \{ {X}^{( l )} \} = x {⊗}_{P}^{N} {b}^{( l )} \qquad ( 20 )$$

Due to expression of b^{(l)}=[b^{(l)}(0), b^{(l)}(1), . . . , b^{(l)}(N−1)]

$${b}^{( l )} ( n ) = N \sqrt{\frac{sin α + jcosα}{N}} {e}^{j - \frac{1}{2} cot {α ( i M )}^{2} Δ {t}^{2}} {\sum }_{i = 0}^{L - 1} {r ( i )}^{( l )} δ ( n - i M ) \\ n = 0 , 1 … N - 1 , \\ l = 1 , 2 , … , S \qquad ( 21 )$$

Which: r^{(l)} (i)=IDFT{R^{(l)}(m)}. Bring formula (19) into the formula (18) can obtain:

$${\tilde{x}}^{( l )} ( n ) = {\sum }_{i = 0}^{L - 1} {r}^{( l )} ( i ) {x ( ( n - i M ) )}_{P , N} {R}_{N} ( n ) {e}^{j \frac{1}{2} cot α [ - 2 i M n + {( i M )}^{2} ] Δ {t}^{2 }} \\ n = 0 , 1 … N - 1 , \\ l = 1 , 2 , … S \qquad ( 22 )$$

Which:

$${R}_{N} ( n ) = \{ \begin{matrix}1 & 1 \leq n \leq N - 1 \\ 0 & Other\end{matrix}$$

is the value of the primary value range; x((n−iM))_{P,N}R_{N}(n) is signal which is obtained by periodic extension of chirp with N-cycle and p-order, and then carry it on a circular movement. That is, according to the formula (21) shows the cycle of the chirp, x((n))_{P,N} can be obtained by periodic extension of chirp.

That is, according to the formula (21) the chirp cycle is shown, the X is extended to the chirp cycle, then the P is shifted and the main value range is taken.

$$x ( n - N ) {e}^{j \frac{1}{2} cot {α ( n - N )}^{2} Δ {t}^{2}} = x ( n ) {e}^{- j \frac{1}{2} cot α {n}^{2} Δ {t}^{2}} \qquad ( 23 )$$

Making

$$η ( n , i ) = {e}^{j \frac{1}{2} cot α [ - 2 i M n + {( i M )}^{2} ] Δ {t}^{2}} ,$$

then η(n,0)=1, formula (20) can expressed as formula (22).

$${\tilde{x}}^{( l )} ( n ) = {\sum }_{i = 0}^{L - 1} {r}^{( l )} ( i ) {x ( ( n - i M ) )}_{P , N} {R}_{N} ( n ) η ( n , i ) , \\ n = 0 , 1 … N - 1 \qquad ( 24 )$$

From formula (22) can be seen that this method needs only once IDFRFT. After subcarrier modulation, the candidate signals of FRFT-OFDM can be weighted and obtained directly by the circular shift of the signal in the time domain, and the IDFRFT process is not performed in many times. Select the minimum candidate signals \tilde{x}^{(l)}(n) of PAPR in time domain as transmission signals. The weighting factor r(i)ₒₚₜ which can make PAPR of candidate signals minimum in time domain is used as sideband information, and send it to receiving end.

$${r ( i )}_{opt} = arg min {PARP}_{\{ {r}^{( 1 )} ( i ) , … , {r}^{( S )} \}} ( {\tilde{x}}^{( l )} ( n ) \} \qquad ( 25 )$$

Due to the b^{(l)} sequence has only L non zero that reduce the computation complexity of fractional circular convolution between x and b^{(l)}, that is, FRFT-OFDM symbols x(n) in time domain can be obtained by a N-point IDFRFT; All the candidate signals are obtained by the method that making the x (n) periodic continuation and the circular shift based on chirp, and then the results are weighted. This method avoids the parallel computation of multiple N points of IDFRFT like SLM and PTS. System selects the signal with the minimum PAPR as sideband information which will be sent to the receiving end. FIG. 1 shows the principle of the method in the transmitter. As long as the receiving end discrete Fourier transform r^{(l)}(i) into R^{(l)}(m), B can be obtained in accordance with the formula (13) and formula (14), and then the transmitted signal can be recovered.

C. The Computational Complexity Analysis of Low Complexity Suppression of PAPR

In order to get time-domain FRFT-OFDM signal x after subcarrier modulated, it need a N-point IDFRFT in this suppression of PAPR. In the implementation of the project, there are a variety of DFRFT discrete algorithms. In this paper, we use the Pei DFRFT algorithm which can perform a N-point IDFRFT. And this algorithm needs a complex multiplication operation with

$$2 N + \frac{N}{2} {log}_{2} N$$

times. In order to obtain x((n−iM))_{P,N}R_{N}(n), we need to turn left for a period of periodic extension of chirp and we need a N-times complex multiplication at this time. It needn't to repeat the calculation, because φ(n,i) are the same for each alternative. And the number of φ(n,i) is L which can be obtained by (L−1) N-times complex multiplication. According to the formula (18), candidate signals whose number is S can be obtained by making φ(n,i) and r^{(l)}(i) weighted. At this time, each candidate signals can be obtained by NL-times complex multiplication. Therefore, the entire method needs a total number of complex multiplication be shown:

$$2 N + \frac{N}{2} {log}_{2} N + N + ( L - 1 ) N + LNS = ( 2 + L ) N + \frac{N}{2} {log}_{2} N + LNS \qquad ( 26 )$$

Due to only a N-point IDFRFT in this method and the value of L is not large. In general, when the L is 4, inhibitory effect of this suppression is very well, so, the proposed method has lower computational complexity than that of SLM and PAPR. Table 1 is a summary that the number of candidate signals generated and the number of complex multiplication by the SLM, the PTS, and the method of the invention.

TABLE 1
the computational complexity of SLM, PTS, and the proposed method

| Method | Main calculation | Complex times |
|---|---|---|
| SLM | Take M₁ times IDFRFT with N-point, resulting in alternative signals whose number is M₁ | $K ( 2 N + \frac{N}{2} {log}_{2} N ) + {NKM}_{2}$ |
| PTS | Take IDFRFT with N- point and K-number, resulting in alternative signals whose number is M₂ | ${M}_{1} ( 2 N + \frac{N}{2} {log}_{2} N ) + {M}_{1} N$ |
| The method of the invention | Take once IDFRFT with N-point, resulting in alternative signals whose number is S | $( 2 + L ) N + \frac{N}{2} {log}_{2} N + NLS$ |

### BRIEF DESCRIPTION OF FIGURES

FIG. 1. A block diagram of a specific implementation method of the present invention.

FIG. 2. The BER comparison of before and after the PAPR suppression is introduced into a FRFT-OFDM system.

FIG. 3. Suppression characteristics contrast of PAPR with the method of the present invention when L=2, 4.

FIG. 4. Suppression characteristics contrast of PAPR by the SLM method, the PTS method, and the method of the present invention when candidate signals is 32 and sampling factor J=1.

FIG. 5. suppression characteristics contrast of PAPR by the SLM method, the PTS method, and the method of the present invention when candidate signals is 32 and sampling factor J=4.

### EXAMPLES

The following examples are provided by way of illustration only, and not by way of limitation.

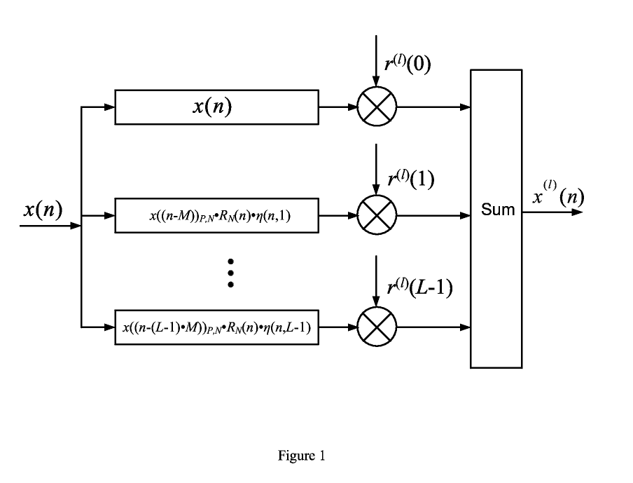

FIG. 1 is a block diagram of a specific implementation method of the present invention.

(1) Carry out N-point IDFRFT of the complex data X after digital modulation which length is N at sending end of communication system. After the process of subcarrier modulation, FRFT-OFDM symbols x(n) in time domain can be obtained; N is number of subcarriers; IDFRFT is inverse discrete fractional Fourier transform; x(n) is symbol of time-domain FRFT-OFDM symbol.

(2) According to periodic of chirp, making out p-order periodic extension of the x(n) in time domain of chirp and obtaining extended sequence which is represented as x((n))_{P,N}. p-order discrete fractional Fourier converted into the formula of periodic extension in time domain of chirp is:

$$x ( n - N ) {e}^{j \frac{1}{2} cot {α ( n - N )}^{2} Δ {t}^{2}} = x ( n ) {e}^{- j \frac{1}{2} cot α {n}^{2} Δ {t}^{2}} \qquad ( 9 )$$

chirp is a linear FM; p is the order of Fractional Fourier Transform Order; x((n))_{P,N} is the extended sequence which is obtained by p-order periodic extension of the x(n) in time domain of chirp; N is the chirp cycle length (in the present invention, the chirp cycle length is equal to the number of sub carriers); α=pπ/2, dt is the sampling interval of continuous signal.

(3) Move x((n))_{P,N} to the right of the iM (i=1, 2, . . . L) point, take the main value range of x((n))_{P,N} and obtain chirp circumferential displacement of FRFT-OFDM time domain signal—x((n−iM))_{P,N}R_{N}(n); L is the length of the random phase sequence;

(4) Multiply x((n−iM))_{P,N}R_{N}(n) and

$$η ( n , i ) = {e}^{j \frac{1}{2} cot α [ - 2 i M n + {( i M )}^{2} ] Δ {t}^{2}}$$

by point, get φ(n,i) is:

φ(n,i)=x((n−iM))_{P,N}R_{N}(n)η(n,i),i=0,1 . . . L−1,n=0,1, . . . ,N−1 (10)

(5) Weighted stacking of φ(n,i) by r^{(l)}(i), get candidate signals \tilde{x}^{(l)}(n) of FRFT-OFDM time domain is:

$${\tilde{x}}^{( l )} ( n ) = {\sum }_{i = 0}^{L - 1} {r}^{( l )} ( i ) ϕ ( n , i ) , n = 0 , 1 … N - 1 , l = 1 , 2 , … S \qquad ( 11 )$$

S is the number of alternative Fractional random phase sequence.

(6) Select the minimum candidate signals \tilde{x}^{(l)}(n) of PAPR in time domain as transmission signals. The weighting factor r(i)ₒₚₜ which can make PAPR of candidate signals minimum in time domain is used as sideband information, and send it to receiving end. According to sideband information r(i)ₒₚₜ, the receiving end recovers sending-information.

$${r ( i )}_{opt} = arg min {PARP}_{\{ {r}^{( 1 )} ( i ) , … , {r}^{( S )} \}} \{ {\tilde{x}}^{( l )} ( n ) \} \qquad ( 12 )$$

In order to illustrate the effectiveness of the method in the present invention, a specific example and analysis are given here. With the increasing number of subcarriers, the performance difference of PAPR in FRFT-OFDM system which is leaded by the difference of order can get smaller and smaller. When the number of sub carriers is great, the PAPR distribution of FRFT-OFDM system with different order is consistent. So we take the order of 0.5 in the simulation example, and other simulation parameters are shown in Table 2.

TABLE 2
simulation parameters

| Parameters | Parameter values |
|---|---|
| Monte Carlo simulation | 10⁵ |
| Number of subcarrier number | 256 |
| Digital modulation | QPSK modulation |
| Channel type | Gauss white noise channel |

Table 3 gives the main calculation quantity and the times of complex multiplication under the simulation example. At this point, the method of the invention, the weighting factor is r^{(l)}(i)ε{1,−1,j,−j}. We take the elements of the random phase sequence to Pₖ^{(u)ε{}1,−1,j,−j} with the method of SLM. With the method of PTS, phase factor is aₖ^{(λ)} ε{1,−1,j,−j}. The proposed method has lower computational complexity than which of SLM and PAPR.

TABLE 3
the computation complexity of the 3 methods with specific parameters

| | Main | Times of complex |
|---|---|---|
| Method | calculation | multiplication |
| SLM, M₁ = 32 | IDFRFT with 32-time and | 49152 |
| | 256-point, resulting in | |
| | alternative 32 signals | |
| PTS, M₂ = 32, | IDFRFT with 4-time and | 6144 |
| K = 4 | 256-point, resulting in | |
| | alternative 32 signals | |
| The method of this | IDFRFT with one time and | 2560 |
| invention, S = 32, | 256-point, resulting in | |
| L = 4 | alternative 32 signals | |

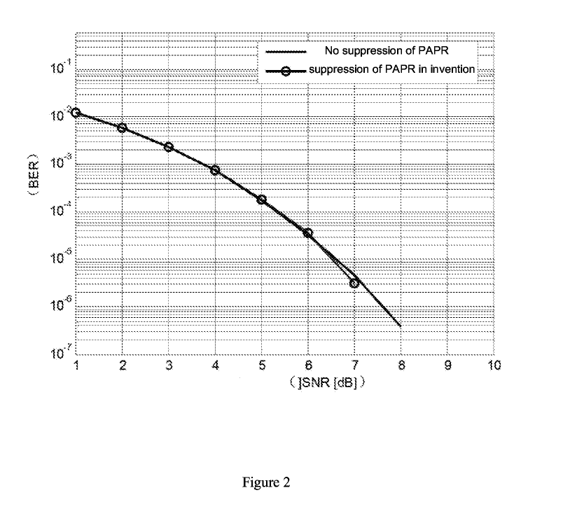

FIG. 2 is the BER comparison of before and after the PAPR suppression is introduced into a FRFT-OFDM system. From FIG. 2, it can be seen that the BER comparison of before and after the PAPR suppression is introduced into a FRFT-OFDM system is consistent. And then the reliability of the method is verified, that is, with the method of the invention, the receiving end can accurately recover the information of the sending end.

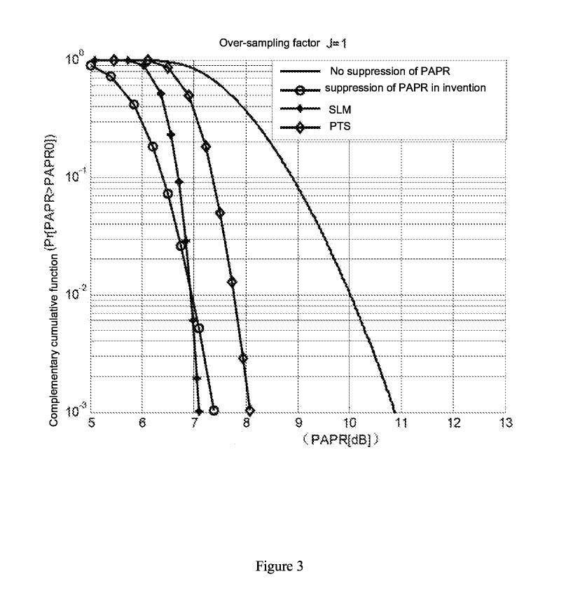

FIG. 3 is suppression characteristics contrast of PAPR with the method of the present invention when L=2, 4. From FIG. 3, it can be seen that the PAPR suppression can effectively improve the PAPR distribution of the system. When L=², the PAPR of the system was reduced by about 2.0 dB than the system without this suppression of PAPR. When L=⁴ and CCDF=10⁻³ the suppression effect of PAPR has about 1.5 dB gain. But from table 1 can be obtained, with the increasing value of L, the complexity of the method also increases accordingly.

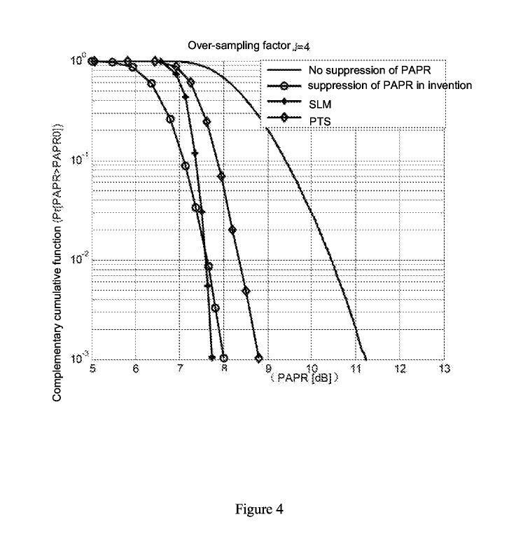

FIG. 4 is suppression characteristics contrast of PAPR by the SLM method, the PTS method, and the method of the present invention when candidate signals is 32 and sampling factor J=1. From FIG. 4, it can be seen that value of PAPR is greater than 7 dB when the number of candidate signal is 32, and the PAPR suppression effect of the proposed method is slightly worse than that of the SLM method. However, from the FIG. 3, it can be seen that the computational complexity of the proposed method is only 5.21% of the SLM method. When the number of candidate signal is 32, the PAPR suppression effect of the proposed method is better than that of the PTS method. When CCDF=10⁻², comparison with PTS method, the suppression effect of PAPR has about 0.7 dB gain. From the FIG. 3, it can be seen that the computational complexity of the proposed method is 41.67% of PTS.

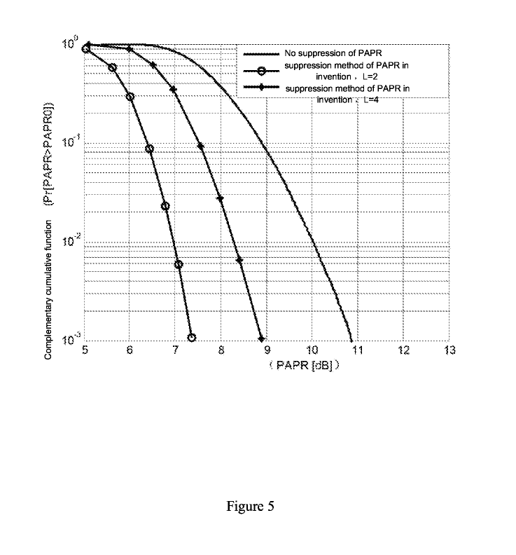

FIG. 5 is suppression characteristics contrast of PAPR by the SLM method, the PTS method, and the method of the present invention when candidate signals is 32 and sampling factor J=4. In order to be closer to the continuous feature of the OFDM symbol, when compute the PAPR characteristics of OFDM symbol. It is generally believed that it can basically simulate the continuous characteristics of OFDM symbols when the sampling factor is taken J=4. From FIG. 4 and FIG. 5, it can be seen that over-sampling factor J=4 comparison with over-sampling factor J=1, SNR of each method has about 0.5 dB of attenuation.

To the specific description of the above, objectives, technical solutions and advantages of the invention has been described in detail. It should be understood that the above description is only the specific embodiment of the present invention and it cannot be intended to define the scope of the invention.

What is claimed is:

1. A method that low complexity suppression of PAPR in FRFT-OFDM system, characterized in that the steps of the method are follows:
1) carry out N-point IDFRFT of the complex data X after digital modulation which length is N at sending end of communication system; after the process of subcarrier modulation, FRFT-OFDM symbols x(n) in time domain can be obtained;
2) according to periodic of chirp, making out p-order periodic extension of the x(n) in time domain of chirp and obtaining extended sequence which is represented as x((n))_{P,N}; p-order discrete fractional Fourier converted into the formula of periodic extension in time domain of chirp is:
$$x ( n - N ) {e}^{j \frac{1}{2} cot {α ( n - N )}^{2} Δ {t}^{2}} = x ( n ) {e}^{- j \frac{1}{2} cot α {n}^{2} Δ {t}^{2}} \qquad ( 9 )$$
3) move x((n))_{P,N} to the right with the iM (i=1, 2, . . . L) point, take the main value range of x((n))_{P,N} and obtain chirp circumferential displacement of FRFT-OFDM signals in time domain—x((n−iM))_{P,N}R_{N}(n);
4) Multiply x((n−iM))_{P,N}R_{N}(n) and
$$η ( n , i ) = {e}^{j \frac{1}{2} cot α [ - 2 i M n + {( i M )}^{2} ] Δ {t}^{2}}$$
by point, get φ(n,i) is:
φ(n,i)=x((n−iM))_{P,N}R_{N}(n)η(n,i),i=0,1 . . . L−1,n=0,1, . . . ,N−1 (10)
5) weighted stacking of φ(n,i) by r^{(l)}(i) in step (4), get candidate signals \tilde{x}^{(l)}(n) of FRFT-OFDM in time domain is:
$${\tilde{x}}^{( l )} ( n ) = {\sum }_{i = 0}^{L - 1} {r}^{( l )} ( i ) ϕ ( n , i ) , n = 0 , 1 … N - 1 , l = 1 , 2 , … S \qquad ( 11 )$$
6) select the minimum candidate signals \tilde{x}^{(l)}(n) of PAPR in time domain as transmission signals. The weighting factor r(i)ₒₚₜ which can make PAPR of candidate signals minimum in time domain is used as sideband information, and send it to receiving end. According to sideband information r(i)ₒₚₜ, the receiving end recovers sending-information;
$${r ( i )}_{opt} = arg min {PARP}_{\{ {r}^{( 1 )} ( i ) , … , {r}^{( S )} \}} \{ {\tilde{x}}^{( l )} ( n ) \} \qquad ( 12 )$$
Wherein, FRFT is fractional Fourier transform; OFDM is an orthogonal frequency division multiplexing; FRFT-OFDM is orthogonal frequency division system which is based on Fractional Fourier Transform; N is the number of subcarriers; X is the complex data after digital modulation which length is N; IDFRFT is inverse discrete fractional Fourier transform; x (n) is the symbol of the time-domain FRFT-OFDM; chirp is a linear FM; p is the order of Fractional Fourier Transform; x((n))_{P,N} is the extended sequence which is obtained by p-order periodic extension of chirp in time domain; N is the cycle length of chirp (in the present invention, the cycle length of chirp is equal to the number of sub carriers); α=pπ/2, dt is the sampling interval of continuous signals; L is the length of the random phase sequence; M=N/L,
$${R}_{N} ( n ) = \{ \begin{matrix}1 & 1 \leq n \leq N - 1 \\ 0 & Other\end{matrix}$$
is the value of the primary value range; r₍ₗ₎(i) is the weighting factor with L-length, S is the number of alternative Fractional random phase sequence, PAPR is the peak to average power ratio.
